(19) United States
(12) Patent Application Publication
(10) Pub. No.: US 2022/0227058 A1
(43) Pub. Date: Jul. 21, 2022

(54) CHAMBER TEMPERATURE CONTROL

(71) Applicant: HEWLETT-PACKARD DEVELOPMENT COMPANY, L.P., Spring, TX (US)

(72) Inventors: Eduard Galdeano Castillo, Sant Cugat del Valles (ES); Guillermo Moliner Clemente, Sant Cugat del Valles (ES); Alejandro Torres Pinero, Sant Cugat del Valles (ES)

(73) Assignee: HEWLETT-PACKARD DEVELOPMENT COMPANY, L.P., Spring, TX (US)

(21) Appl. No.: 17/609,271

(22) PCT Filed: Oct. 25, 2019
(86) PCT No.: PCT/US2019/058008

§ 371 Date: Nov. 5, 2021

(51) Int. Cl. B29C 64/393; F25B 21/04; G05D 23/19; B29C 64/295; B33Y 10/00; B33Y 30/00; B33Y 50/02

(52) U.S. Cl. CPC B29C 64/393; F25B 21/04; G05D 23/1931; B33Y 50/02; B33Y 10/00; B33Y 30/00; B29C 64/295

(57) ABSTRACT

A system (2) is provided with a temperature controlled chamber (4) having a wall (6) extending about a space (8) to receive a three-dimensional printed job. A plurality of temperature control elements (10,12) are mounted to the wall, wherein each of the temperature control elements is operable separately from each other of the temperature control elements. A controller (14) operates the plurality of temperature control elements, each of which is selectively operable by the controller in dependence upon parameters of a three-dimensional printed job to be temperature controlled within the chamber.

### BACKGROUND

Additive manufacturing machines produce 3D objects by building up layers of material. Some additive manufacturing machines are commonly referred to as “3D printers”. 3D printers and other additive manufacturing machines make it possible to convert a CAD (computer aided design) model or other digital representation of an object into the physical object. The model data may be processed into slices each defining that part of a layer or layers of build material to be formed into the object. Build material may comprise any suitable form of build material, for example fibres, granules or powders. The build material can include thermoplastic materials, ceramic material and metallic materials.

### BRIEF DESCRIPTION OF THE DRAWINGS

Some non-limiting examples of the present disclosure will be described in the following with reference to the appended drawings in which:

FIG. 1 is a schematic perspective view of a first system according to an example;

FIG. 2 is a schematic perspective view of a second system according to an example;

FIG. 3 is a schematic perspective view of the second system of FIG. 2, the second system operating according to an example;

FIG. 4 is a graph showing the rate of cooling according to an example; and

FIG. 5 is a schematic perspective view of an additive manufacturing machine according to an example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilised and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

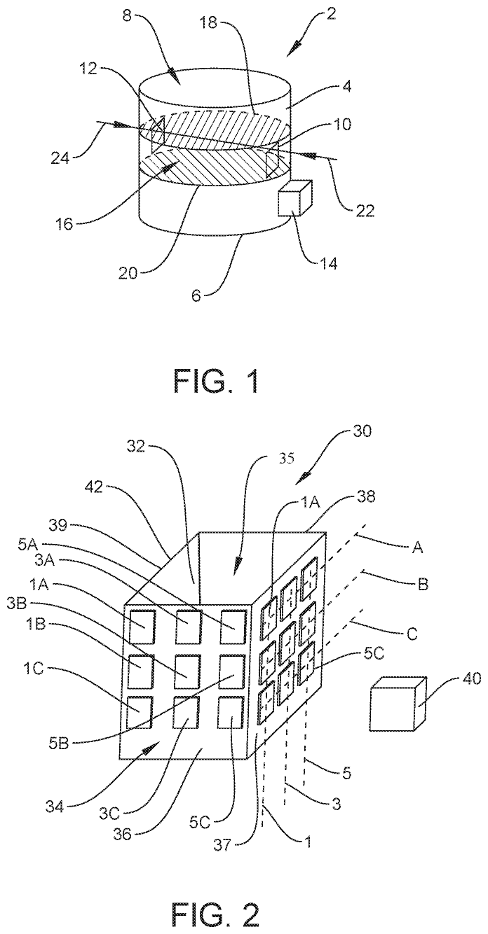

An example of the present disclosure is a system 2 as shown schematically in the accompanying FIG. 1. The system 2 has a temperature controlled chamber 4, the chamber 4 having a wall 6 extending about a space 8 to receive a three-dimensional printed job (not shown).

A plurality of temperature control elements 10,12 are mounted to the wall 6, wherein each of the temperature control elements 10 is operable separately from each other of the temperature control elements 12.

A controller 14 is provided to operate the plurality of temperature control elements 10,12. Each of the temperature control elements 10,12 is selectively operable by the controller 14 in dependence upon parameters of a three-dimensional printed job to be temperature controlled within the chamber 4.

The plurality of temperature control elements 10,12 are arranged in pairs. The system 2 shown in FIG. 1 has two temperature control elements 10,12 which thereby provides one pair of temperature control elements 10,12. The temperature control elements 10,12 of this pair are located opposite one another on opposing sides of the chamber 4.

In another example of the present disclosure, more than one pair of temperature control elements are provided. In an example where more than one pair of temperature control elements are provided, each pair is located opposite one another on opposing sides of the chamber. Temperature control elements are arranged in a pair in as much as they are operated together by the controller 14.

In one example, temperature control elements are operated together in that they are operated in the same way to have the same temperature controlling effect on a zone within the chamber (i.e. a volume within the chamber). In another example, the temperature control elements are operated together in that they are operated in a different way to have a different temperature controlling effect and thereby create a zone of graduated cooling between the elements where the cooling effect becomes progressively stronger when moving through the zone from one element towards the other. The temperature control elements in a pair are thereby operated together in a coordinated way so as to produce a cooling effect in a zone (i.e. volume) of the chamber.

In the system of FIG. 1, the controller 14 is configured to selectively operate a temperature control element 10 located in a first plane and selectively operate a temperature control element 12 located in a second plane. The controller 14 coordinates operation of temperature control elements 10,12 to control the temperature of a zone 16 of the chamber 4 (specifically a zone 16 of the space 8 in which a three-dimensional printed job is received) from two directions. In FIG. 1, the zone 16 is the region (or a volume) between imaginary upper plane 18 and lower plane 20, and the two directions are indicated by first and second arrows 22,24. The zone 16 is that part of the space 8 where the temperature control elements 10,12 have effectiveness in controlling temperature.

The controller 14 is configured to analyse a zone 16 of a three-dimensional printed job (not shown) to determine a rate of heat transfer for the zone 16 that reduces thermal distortion from cooling of the three-dimensional printed job. Analysing a zone includes analysing a three-dimensional printed job or the portions of a three-dimensional printed job located in the zone. The controller 14 is configured to selectively operate temperature control elements 10,12 to vary the temperature of the zone 16 in accordance with the determined heat transfer rate.

In the example shown, each temperature control element 10,12 is a solid-state active heat pump. In one example, each temperature control element 10,12 is a Peltier element. Such elements can be electrically driven to either heat or cool.

In the example of FIG. 1, the wall 6 of the chamber 4 is cylindrical in shape and the temperature control elements 10,12 are mounted on the curved surface of the wall 6.

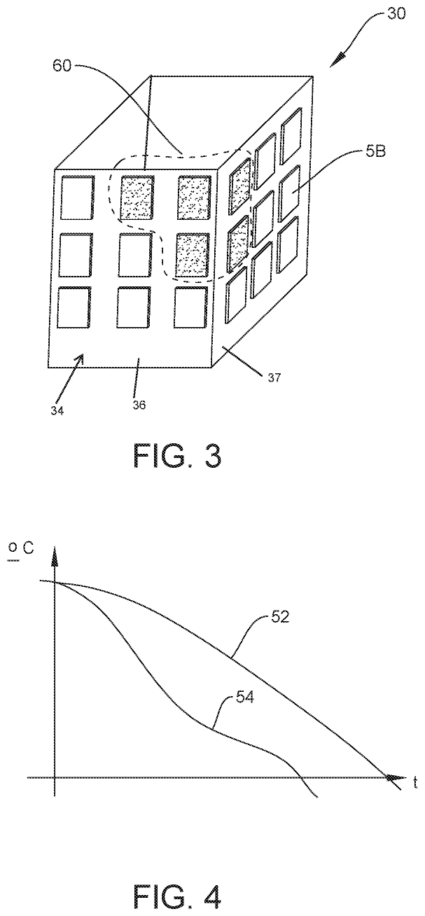

FIGS. 2 and 3 of the accompanying drawings show another example of the present disclosure. These FIGS. 2 and 3 show a system 30 with a temperature controlled chamber 32, the chamber 32 having a wall 34 extending about a space 35 to receive a three-dimensional printed job (not shown). The chamber 32 is open at the top of the wall 34.

The wall 34 has four square-shaped side panels 36,37,38,39 of equal size, which adjoin one another to define a space 35 having a cubic shape.

A plurality of temperature control elements are mounted to each side panel 36,37,38,39 of the wall 34. Each of the temperature control elements is operable separately from each other of the temperature control elements.

A controller 40 is provided to operate the temperature control elements.

The plurality of temperature control elements are arranged in a matrix of rows and columns. Specifically, the plurality of temperature control elements on each side panel 36,37,38,39 are arranged in a matrix of rows and columns. The rows and columns are equi-spaced from one another. With this equi-spacing is such that the temperature control elements are uniformly distributed over the area of each side panel.

In another example, there is no spacing between the rows and columns.

In an example, each side panel is entirely covered with the plurality of temperature control elements. In this example, the temperature control elements are abutting one another.

The arrangement of the temperature control elements on each of the four side panels 36,37,38,39 will be described with reference to the first and second panels 36,37 of the wall 34. The other two panels 38,39 of the wall 34 have the same arrangement of temperature control elements.

In FIG. 2, the first and second panels 36,37 are each shown having a total of nine temperature control elements 1A,3A,5A,1B,3B,5B,1C,3C,5C. These temperature control elements are arranged in three rows A,B,C and three columns 1,3,5 (see the second panel 37). A three by three matrix of temperature control elements is thereby provided on each side panels 36,37,38,39. In another example, a four by four matrix of temperature control elements is provided on each side panels 36,37,38,39.

The temperature control elements on any one panel is a first subset of temperature control elements and is arranged in a matrix of rows and columns located in a single plane. The temperature control elements on the panel opposite the mentioned one panel is an opposite subset of temperature control elements arranged in a matrix of rows and columns located in a single plane. The planes of the first and opposite subsets are arranged parallel with one another and on opposing sides of the chamber 32 to one another. By way of example, the first and third panels 36,38 have such first and opposite subsets, as do the second and fourth panels 37,39.

The temperature control elements on any one panel is a first subset of temperature control elements and is arranged in a matrix of rows and columns located in a single plane. The temperature control elements on the panel located laterally to the mentioned one panel is a lateral subset of temperature control elements arranged in a matrix of rows and columns located in a single plane. The planes of the first and lateral subsets are arranged at an angle to one another. By way of example, the first and second panels 36,37 have such first and lateral subsets, as do the second and third panels 37,38. The angle at which these first and second panels are arranged to one another is ninety degrees.

The controller 40 is configured to selectively operate a temperature control element located in a first plane and selectively operate a temperature control element located in a second plane, the controller 40 thereby coordinating operation of temperature control elements to control the temperature of a zone of the chamber 32 from at least two directions. A zone is a volume of the chamber 32 where a selected plurality of temperature control elements have effectiveness in controlling temperature.

The controller 40 is configured to analyse a zone of the chamber 32 to determine a rate of heat transfer for a portion of three-dimensional printed job in the zone that reduces thermal distortion from cooling of the three-dimensional printed job. The controller 40 is also configured to selectively operate temperature control elements to vary the temperature of the zone in accordance with the determined rate of heat transfer.

Temperature control elements on opposing sides of the chamber 32 are selectively operated together to control the temperature in the zone between the elements. For example the temperature control element 1A on the first panel 36 is opposite the temperature control element 5A on the third panel 38. These two temperature control elements can be selectively operated to control (for example, reduce) the temperature of a zone of the space 8 located between these two temperature control elements i.e. a zone of the space 8 located along and adjacent an edge 42 of chamber 32.

Temperature control elements on laterally located sides of the chamber 32 are selectively operated together to control the temperature in the zone adjacent the elements. For example the temperature control element 1A on the first panel 36 is located laterally of the temperature control elements 1A,3A,5A on the fourth panel 39. These temperature control elements can be selectively operated to control (for example, reduce) the temperature of a zone of the space 8 located adjacent these four temperature control elements i.e. a zone of the space 8 located along and adjacent an edge 42 of chamber 32.

The effectiveness of the temperature control can be increased by further coordinating the operation of the temperature control elements. For example, effectiveness of temperature control of the zone located along and adjacent an edge 42 of chamber 32 can be increased by operating both oppositely and laterally located temperature control elements i.e. temperature control elements 1A on first panel 36, temperature control elements 1A,3A,5A on the fourth panel 39, and temperature control element 5A on the third panel 38.

In the system 30 shown in FIGS. 2 and 3, each of the temperature control elements is a Peltier element.

An example of a commercially available Peltier element is the 34.51 W module by Laird Technologies having manufacturing part number 2SC055045-127-63L. This element has an active area of 40×40 mm. The element has a maximum current of 6 A and a maximum voltage of 15.5V, and generates a maximum temperature difference of +83K.

The controller 40 is configured to selectively operate temperature control elements to cool one zone of the chamber and heat another zone of the chamber.

The present disclosure provides a non-transitory computer-readable medium comprising instructions, which when executed on a computing device, cause the computing device to analyse a parameter of a three-dimensional printed job to determine a rate of heat transfer that reduces thermal distortion from cooling of the three-dimensional printed job; and operate a plurality of temperature control elements mounted to a wall of a chamber, each of the temperature control elements being selectively operated by the controller in dependence upon the determined rate of heat transfer.

Analysing a parameter of a three-dimensional printed job includes analysing a zone of a chamber in which the three-dimensional printed job is received, and, for a portion of three-dimensional printed job in the zone, determining a rate of heat transfer that reduces thermal distortion from cooling of the three-dimensional printed job.

Parameters affecting distortion during cooling include the material being used in the additive manufacturing processes as well as the geometry of the three-dimensional printed job. The material will tend to shrink as it is cooled. For example, during natural cooling, portions of three-dimensional printed job which cool faster on a first side thereof than on a second side thereof will tend to shrink faster on the first side than the second side. This can cause warping/bending of a portion of a three-dimensional printed job. Cooling can occur more rapidly on a first side than a second side because, for example, the first side has a greater surface area than the second side. An example is an elongate member where the first and second sides are planar and parallel to one another, but the first side is provide with a large number of recesses. The recesses increase the surface area and increase the rate of cooling and shrinkage of the first side compared to the second side. This may result in warping of the elongate member. If the rate of cooling and shrinkage of the second side is increased to match that of the first side, then the warping will be reduced or avoided. This can be achieved by arranging the second side adjacent temperature control elements and controlling these temperature control elements to increase the rate of cooling that would otherwise occur.

The distortion during natural cooling can be determined with analysis of the three-dimensional printed job, which analysis can be by way of computer modelling. Corrective cooling to reduce or avoid distortion can also be determined with computer modelling.

Operating a plurality of temperature control elements includes varying the heat transfer rate of the zone in accordance with the determined rate of heat transfer.

A non-transitory computer-readable medium as described above can be provided in each of the controller 14 of the system 2 of FIG. 1 and the controller 40 of the system 30 of FIGS. 2 and 3.

The present disclosure provides a method to control the temperature of a three-dimensional printed job. The method includes analysing a parameter of a three-dimensional printed job to determine a rate of heat transfer that reduces thermal distortion from cooling of the three-dimensional printed job. In the method, the three-dimensional printed job is received in a chamber 4,32 having a plurality of temperature control elements mounted to a wall 6,34 of the chamber. The method operates the plurality of temperature control elements, each of the temperature control elements being selectively operated by the controller in dependence upon the determined rate of heat transfer.

In operating the plurality of temperature control elements, a first subset of the plurality of temperature control elements is operated and a second subset of the plurality of temperature control elements is operated, operation of the first and second subsets being coordinated to control the temperature of a portion of a three-dimensional printed job.

The operation of the first subset of the plurality of temperature control elements controls the temperature of a portion of a three-dimensional printed job from a first direction, and operation of the second subset of the plurality of temperature control elements controls the temperature of a portion of a three-dimensional printed job from a second direction.

In analysing a parameter of a three-dimensional printed job, a zone of the chamber is analysed to determine a rate of heat transfer for a portion of three-dimensional printed job in the zone that reduces thermal distortion from cooling of the three-dimensional printed job.

In an example of the present disclosure, the chamber 30 is stand-alone apparatus which is used for controlling the temperature of a three-dimensional printed job. The three-dimensional printed job in (or transferred to) the chamber is one which is hot and in need of carefully controlled cooling to achieve optimum quality of the 3D object produced.

The controller 32 is integral with the chamber 30 or communicates with the chamber 30 from a location remote from chamber 30. A three-dimensional printed job which has been produced in a 3D printer can be immediately transferred from the 3D printer into the chamber 30 for post-processing. A 3D printer and any associated build unit then becomes available for the production of another 3D object.

With the three-dimensional printed job in the chamber 30, the temperature of the three-dimensional printed job is controlled to increase the speed of the post-processing while also ensuring that undesirable distortion and internal stresses in 3D objects produced are minimised. The temperature within the chamber 30 is controlled by operating some or all of the temperature control elements to reduce the temperature within the chamber 30 and thereby cool the three-dimensional printed job. This post-processing of the three-dimensional printed job is quicker than a natural cooling of the three-dimensional printed job. A graph of temperature versus time is provided in FIG. 4, wherein the change of temperature with time for natural cooling (curve 52) is compared with a more rapid change of temperature with time for cooling with the temperature control elements of the present disclosure (curve 54).

During the post-processing of a three-dimensional printed job, some or all of the temperature control elements are controlled to heat the three-dimensional printed job. In this way, the natural rate of cooling is reduced. The temperature control elements may be controlled in this way at the beginning of post-processing. The temperature control elements are then operated to cool the three-dimensional printed job.

As a Peltier element, a temperature control element can selectively heat or cool by exchanging heat from one side of the element to the other side. Each Peltier element has two sides, and when a DC electric current flows through the element, it brings heat from one side to the other so that one side gets cooler while the other side gets hotter. The “hot” side is attached to a heat sink so that it remains at ambient temperature, while the cool side reduces in temperature. If a heater function is needed instead of cooling, the DC electric current is reversed.

The three-dimensional printed job is initially heated by the plurality of Peltier elements. This avoids the onset of natural cooling until a controlled cooling can begin. In an example, the printer is a multi-jet fusion printer and heating is limited to keep the temperature of the three-dimensional printed job below the fusion temperature.

The three-dimensional printed job is initially cooled in a controlled way by the Peltier elements. A Peltier element can generate a maximum temperature difference of around +80 Celsius. So, if a three-dimensional printed job is initially at +150 Celsius, then the Peltier element can provide controlled cooling to +70 Celsius. Further cooling can be provided by stacking additional Peltier elements (known as cascading). A maximum temperature difference of around +100 Celsius can then be achieved. The target temperature for a multi-jet fusion printed part is as recommended to allow a user to manipulate the printed part without damaging it. The cooling time will be affected by the size of the chamber. The bigger the chamber, the larger the pathway which heat needs to follow before being evacuated to environment. Hence, the bigger the chamber, the slower the cooling time will tend to be.

For a three-dimensional printed job made with a Multi-Jet Fusion printer, the temperature from which the three-dimensional printed job begins to cool will depend on the fusing/melting temperature of the build material. The build material is heated to the fusing temperature of the build material during the 3D printing process, and so the three-dimensional printed job begins cooling from this fusing temperature, which is dependent on the build material in use.

Each temperature control element is individually controllable. This allows different zones of the chamber 30 to be temperature controlled in different ways. So, a first subset of temperature control elements can be controlled in one way so as to operate at a lower temperature than a different second subset of temperature control elements which are controlled in a different way. A first zone associated with the first subset (operating at a lower temperature) will experience a greater heat transfer rate than a second zone associated with the second subset (operating at a higher temperature). This can assist in reducing thermal distortion (which includes internal stresses) in a 3D printed object.

For example, a three-dimensional printed job may be susceptible to distortion during post-processing if it has a first portion (for example, a surface or element) which naturally cools more slowly than an adjoining second portion. However, if the controller 32 operates the temperature control elements so the first portion of the three-dimensional printed job is located in the first zone mentioned above (experiencing a greater heat transfer rate) and the second portion of the three-dimensional printed job is located in the second zone (experiencing a lower heat transfer rate), then the rate at which the two portions cool can be controlled to be the same as each or more similar to one another than with natural cooling. In this way, distortion during post-processing is avoided or reduced.

The thermal distortion arising from the cooling of a three-dimensional printed job is affected by parameters of the three-dimensional printed job, such as the size and shape of the 3D objects to be produced and the build material with which they are produced. The effect of these parameters on thermal distortion of the three-dimensional printed job can be modelled with computational techniques or measured, and a determination can then be made as to how each of the temperature control elements should be controlled to avoid or reduce the thermal distortion.

In FIG. 3 of the accompanying drawings, a subset of temperature control elements (elements 3A,5A,5B on first panel 36, and elements 1A,1B on second panel 37—reference numbers for these elements are shown only in FIG. 2) is shown operating at a lower temperature than the other temperature control elements so that heat is transferred at a higher rate from an associated zone of the chamber 32 in which a portion of a three-dimensional printed job is located and has a higher temperature than other portions of the three-dimensional printed job. Higher temperatures will arise where the mass of the three-dimensional printed job is greater so that more heat energy is stored. The higher temperature portion of the three-dimensional printed job elevates the temperature of the wall 34 in the ‘hot’ area enclosed by imaginary broken line 60. The selective and coordinated operation of the subset of temperature control elements in FIG. 3 transfers heat away from the ‘hot’ area of the wall 34 and the aforementioned associated zone of the chamber 32 at an increased rate, and as a consequence the temperature of the ‘hot’ area and the aforementioned associated zone is reduced or maintained the temperature of the remainder of the wall 34 and chamber 32. So, the temperature uniform throughout the whole of the three-dimensional printed job (the ‘cake’).

The temperature control elements can be selectively operated to control the temperature of top, bottom, central, right and left zones.

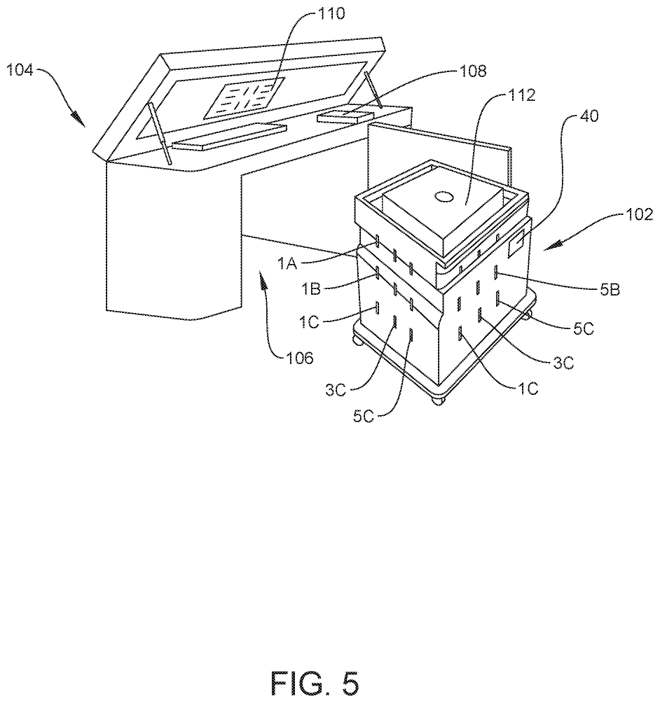

In an example of the present disclosure, the chamber 30 and controller 40 of FIG. 2 is incorporated into a 3D printer or into a build unit used with a 3D printer (see FIG. 5).

In FIG. 5, a 3D printing system is shown schematically. The system has a mobile build unit 102 and a 3D printer 104, wherein the printer 104 has a build chamber 106, a printhead 108 movable across the build chamber 106, and a printer heater 110 to heat the build chamber 106. The build unit 102 is locatable in the build chamber 106 and is removable from the build chamber 106. The mobile build unit 102 has a build platform 112 to receive build material (not shown).

The chamber 30 shown in FIG. 2 is incorporated within the mobile build unit 102. The chamber 30 is located inside the mobile build unit 102 and not visible in FIG. 5, but indicative positions of nine temperature control elements 1A,3A,5A, 1B,3B,5B,1C,3C,5C of two panels are shown schematically. The controller 40 is located on a side of the mobile build unit 102.

Build material may comprise any suitable form of build material, for example short fibres, granules or powders. A powder may include short fibres that may, for example, have been cut into short lengths from long strands or threads of material. The build material can include thermoplastic materials, ceramic material and metallic materials. In examples, fusing agent is used. In other examples, binding agent is used. Binding agents may include chemical binder systems, such as in binder jet or metal type 3D printing. The present disclosure is applicable to these build materials. The present disclosure is applicable when fusing or binding agent is used, as mentioned above. The present disclosure is applicable whenever the three-dimensional printed job needs to be cooled in a controlled way in order to ensure print quality.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited by the claims and the equivalents thereof.

1. A system comprising a temperature controlled chamber, the chamber having a wall extending about a space to receive a three-dimensional printed job;
a plurality of temperature control elements mounted to the wall, wherein each of the temperature control elements is operable separately from each other of the temperature control elements; and
a controller to operate the plurality of temperature control elements, each of the temperature control elements being selectively operable by the controller in dependence upon parameters of a three-dimensional printed job to be temperature controlled within the chamber.

2. The system claimed in claim 1, wherein the plurality of temperature control elements are arranged in pairs, the temperature control elements of each pair being located opposite one another on opposing sides of the chamber.

3. The system claimed in claim 1, wherein the plurality of temperature control elements are arranged in a matrix of rows and columns.

4. The system claimed in claim 1, wherein a first subset of the plurality of temperature control elements is arranged in a matrix of rows and columns located in a single plane, and an opposite subset of the plurality of temperature control elements is arranged in a matrix of rows and columns located in a single plane, the planes of the first and opposite subsets being arranged parallel with one another and on opposing sides of the chamber to one another.

5. The system claimed in claim 1, wherein a first subset of the plurality of temperature control elements is arranged in a matrix of rows and columns located in a single plane, and a lateral subset of the plurality of temperature control elements is arranged in a matrix of rows and columns located in a single plane, the planes of the first and lateral subsets being arranged at an angle to one another.

6. The system claimed in claim 1, wherein the controller is configured to selectively operate a temperature control element located in a first plane and selectively operate a temperature control element located in a second plane, the controller thereby coordinating operation of temperature control elements to control the temperature of a zone of the chamber from at least two directions.

7. The system claimed in claim 6, wherein the controller is configured to analyse a zone of the chamber to determine a rate of heat transfer for a portion of three-dimensional printed job in the zone that reduces thermal distortion from cooling of the three-dimensional printed job; and to selectively operate temperature control elements to vary the temperature of the zone in accordance with the determined rate of heat transfer.

8. The system claimed in claim 1, wherein the controller is configured to selectively operate temperature control elements to cool one zone of the chamber and heat another zone of the chamber.

9. The system claimed in claim 1, wherein each temperature control element comprises a Peltier element.

10. A method to control the temperature of a three-dimensional printed job, the method comprising:
analysing a parameter of a three-dimensional printed job to determine a rate of heat transfer that reduces thermal distortion from cooling of the three-dimensional printed job;
receiving the three-dimensional printed job in a chamber having a plurality of temperature control elements mounted to a wall of the chamber;
operating the plurality of temperature control elements, each of the temperature control elements being selectively operated by the controller in dependence upon the determined rate of heat transfer.

11. The method claimed in claim 10, wherein operating the plurality of temperature control elements comprises operating a first subset of the plurality of temperature control elements and operating a second subset of the plurality of temperature control elements, operation of the first and second subsets being coordinated to control the temperature of a portion of a three-dimensional printed job.

12. The method claimed in claim 11, wherein operation of the first subset of the plurality of temperature control elements controls the temperature of a portion of a three-dimensional printed job from a first direction, and operation of the second subset of the plurality of temperature control elements controls the temperature of a portion of a three-dimensional printed job from a second direction.

13. The method claimed in claim 12, wherein analysing a parameter of a three-dimensional printed job comprises analysing a zone of the chamber to determine a rate of heat transfer for a portion of three-dimensional printed job in the zone that reduces thermal distortion from cooling of the three-dimensional printed job.

14. A non-transitory computer-readable medium comprising instructions, which when executed on a computing device, cause the computing device to:
analyse a parameter of a three-dimensional printed job to determine a rate of heat transfer that reduces thermal distortion from cooling of the three-dimensional printed job; and
operate a plurality of temperature control elements mounted to a wall of a chamber, each of the temperature control elements being selectively operated by the controller in dependence upon the determined rate of heat transfer.

15. The non-transitory computer-readable medium claimed in claim 14, wherein analysing a parameter of a three-dimensional printed job comprises analysing a zone of a chamber in which the three-dimensional printed job is received, and, for a portion of three-dimensional printed job in the zone, determining a rate of heat transfer that reduces thermal distortion from cooling of the three-dimensional printed job; and wherein operating a plurality of temperature control elements comprises varying the heat transfer rate of the zone in accordance with the determined rate of heat transfer.
